(19) United States
(12) Patent Application Publication
(10) Pub. No.: US 2008/0288340 A1
(43) Pub. Date: Nov. 20, 2008

(54) SYSTEM AND METHOD FOR PROVIDING A PRE-PAID REBATE CARD

(76) Inventors: Mark Pearson, Edina, MN (US); Kelley Gregory, Shakopee, MN (US); Cletis D. Hoffer, Eden Prairie, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/748,201

(22) Filed: May 14, 2007

(51) Int. Cl. G06Q 30/00; G06Q 40/00

(52) U.S. Cl. 705/14; 705/39

(57) ABSTRACT

The present invention is a system and method for providing pre-paid rebate cards. The present invention may provide a rebate offer to a consumer in relation to a particular purchase. A consumer may then submit a request for redemption of the rebate. A rebate processing center may, among other rebate processing, validate the request for redemption from the consumer and notify a financial institution of the request. The financial institution may subsequently issue the pre-paid rebate card to the consumer. The financial institution may further fulfill payment obligations upon consumer use of the pre-paid rebate card. The present invention may include a three-party agreement between the merchant, the rebate processing center, and the financial institution. The agreement may also provide for the financial institution to indemnify the merchant and the rebate processing center from at least a portion of the risk and/or loss associated with the present system and method.

### FIELD OF THE INVENTION

The present invention relates to the redemption of product marketing rebates. Particularly, the present invention relates to pre-paid rebate cards. More particularly, the present invention relates to systems and methods for providing pre-paid rebate cards to consumers, including a three-party agreement between a merchant offering a rebate, a rebate processing center, and a financial institution supplying pre-paid rebate cards.

### BACKGROUND OF THE INVENTION

Commercial businesses are constantly looking for new ways to retain and/or increase client base. Product marketing rebates are well-known to most consumers and have been used by manufacturers as a tool for promoting and selling products by providing customers with an incentive to purchase particular products, sometimes during a specific period. Typically, in a rebate system, a consumer will purchase a product and subsequently submit a rebate claim for that product along with identifying information, such as the consumer's name, address, telephone number, e-mail address, etc. This criteria typically includes filling out a specific rebate form with the name and address of the consumer, enclosing a cash register receipt showing where and when the item was purchased, and sometimes enclosing the Universal Product Code (UPC) or other designated portion of the product packaging to show that the product was actually consumed. On receipt of the rebate claim and consumer identifying information, the manufacturer, or an agent of the manufacturer, such as a rebate processing center, will transfer the value of the rebate to the consumer. Thus, the consumer is provided with an incentive to purchase products having rebate offers.

Recently, commercial businesses have offered rebates in the form of rebate loyalty cards. In such methods, consumers submit a rebate claim as before. However, rather than receiving a check, the consumers receive a rebate loyalty card for the amount of the rebate that the consumer may use at the commercial business that offered the initial rebate. A drawback of the prior art rebate loyalty card systems is that a consumer must use the rebate card at a commercial business that is specified for them. Also, if several retailers were to issue rebate loyalty cards, the consumer's wallet or pocketbook would soon be bulging with rebate loyalty cards for every retailer they patronize, e.g., drug store, grocery store, electronics store, office supply store, toy store, department store, restaurant, etc. Thus, in many instances, the consumer is worse off with a rebate loyalty card than with a simple rebate check. Additionally, there is some financial burden on the retailer that is inherent in the administration of a loyalty card system. Similarly, the commercial business that initially offers a rebate will not likely want to financially support a rebate card program wherein the consumer can use the rebate at any location the consumer desires, such as any location that accepts payment by credit.

Therefore, there is a need for a system and method for providing pre-paid rebate cards to consumers that are easy for consumers to use and provide a pre-paid rebate card solution for rebate offers, wherein a three-party agreement between a merchant offering a rebate, a rebate processing center, and a financial institution supplying pre-paid rebate cards creates benefits for each party involved. There is also a need for a system and method for providing pre-paid rebate cards that provides benefits to consumers, financial institutions, rebate processing centers, and merchants.

### BRIEF SUMMARY OF THE INVENTION

The present invention, in one embodiment, is a system for providing pre-paid rebate cards. The system comprises three entities. A first entity provides a rebate offer to consumers in relation to a specified purchase. A second entity validates rebate claims from the consumers and provides information relating to the requests to a third entity. A third entity issues pre-paid rebate cards to the consumers based on the information received from the second entity and further fulfills payment obligations upon consumer use of the pre-paid rebate cards. In some embodiments, the second entity may be an agent of the third entity. Furthermore, the second entity may provide to the third entity a monetary value of less than face value of the issued pre-paid rebate cards, and the first entity may provide to the second entity a monetary value of more than the value provided to the third entity by the second entity. In some embodiments, the value provided by the first entity to the second entity may be near, or equal to, face value of the pre-paid rebate cards. The third entity may retain slippage from nonuse of the total value of the pre-paid rebate cards. In further embodiments, the third entity may indemnify the first and second entities from risk and/or loss liabilities. The first entity may be a merchant, the second entity may be a rebate processing center, and the third entity may be a financial institution.

The present invention, in another embodiment, is a method for providing a pre-paid rebate card in response to a rebate claim from a consumer for a rebate offered by a first entity. The method includes providing information relating to the rebate claim to a second entity, wherein the second entity issues a pre-paid rebate card to the consumer and fulfills payment obligations upon use of the pre-paid rebate card by the consumer. The method further includes providing a monetary value to the second entity for a value less than face value of the pre-paid rebate card and receiving a monetary value from the first entity that is more than the monetary value provided to the second entity. In some embodiments, the monetary value received from the first entity is near, or equal to, face value of the pre-paid rebate card. In further embodiments, the method may include obtaining identification from the second entity from risk and/or loss liabilities. The first entity may be a merchant and the second entity may be a financial institution.

The present invention, in yet another embodiment, is a method for providing pre-paid rebate cards in response to a request from a first entity. The method includes receiving from the first entity a monetary value of less than face value of the pre-paid rebate cards, issuing pre-paid rebate cards to consumers based on information provided by the first entity, fulfilling payment obligations relating to consumer use of the pre-paid rebate cards, and assuming a portion or all of the risks and/or losses of the first entity. The method may further include retaining the monetary value associated with slippage in consumer use of the pre-paid rebate cards. The first entity may be a merchant or a rebate processing center.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a flow diagram of a system and method for providing pre-paid rebate cards in accordance with an embodiment of the present invention.

FIG. 2 is a flow diagram of a system and method for providing pre-paid rebate cards in accordance with another embodiment of the present invention, including portions that may not directly involve a consumer.

FIG. 3 is a block diagram representation of a three-party agreement for a system and method of providing pre-paid rebate cards in accordance with yet another embodiment of the present invention.

FIG. 4 is a block diagram representation of payment transfers of a three-party agreement for a system and method of providing pre-paid rebate cards in accordance with another embodiment of the present invention.

### DETAILED DESCRIPTION

The present invention is a novel and advantageous system and method for providing pre-paid rebate cards to consumers. Pre-paid rebate cards shall include any debit or credit card, including Visa®, Mastercard®, Discover®, American Express®, or other credit card, loyalty card, smartcard, scannable device, or other card or device suitable for storing information relating to a pre-paid rebate card or rebate offer. Generally, the present invention may provide a rebate offer to a consumer in relation to the purchase of a particular product or combination of products, such as, for example, a computer, monitor, and printer combination, from a merchant or manufacturer offering the rebate. A consumer may then submit a request to a rebate processing center for redemption of the rebate. A consumer may submit a rebate claim by several methods, generally including, but not limited to, mail, electronically, or telephonically. Similarly, a consumer may submit a rebate claim in accordance with either a traditional paper-based rebate embodiment or a “paperless” rebate embodiment. The rebate processing center may, among other rebate processing, validate the request for redemption from the consumer and notify a financial institution of the request. The rebate processing center may select from a variety of rebate processing and validation systems and methods. The financial institution may subsequently issue the pre-paid rebate card to the consumer. The consumer may then use the pre-paid rebate card at generally any location. The financial institution may further fulfill payment obligations upon consumer use of the pre-paid rebate card. The present invention may generally include a three-party agreement between the merchant, the rebate processing center, and the financial institution. Furthermore, the agreement may provide for the financial institution to indemnify the merchant and the rebate processing center from at least a portion of the risk and/or loss associated with the present pre-paid rebate card system and method.

A pre-paid rebate card may offer several benefits to the consumer. A pre-paid rebate card may be easier to use than a rebate check. Additionally, a pre-paid rebate card of the present invention may allow the consumer to use the rebate card at generally any location that accepts payment by credit rather than only the initial merchant that offered the rebate. Furthermore, an unbanked consumer can avoid the hassle associated with cashing a rebate check at a financial institution, where, for instance, they might be charged a fee.

The present invention similarly provides several benefits to the parties involved, e.g., the merchant, the rebate processing center, and the financial institution. For example, the merchant may provide a more desirable rebate than that of traditional rebate offers without further cost to the merchant. The rebate processing center can avoid handling monetary transfers directly to the consumer upon rebate redemption and can further avoid handling monetary transfers to outside merchants, where the consumer has used the pre-paid rebate card. The term “outside merchant,” as used herein, may include those merchants or other entities that provide goods and/or services that are not the same merchant as the merchant that offered the initial rebate to the consumer. The financial institution may benefit since it becomes a participant in consumer rebate programs. For example, the financial institution may receive income from slippage in consumer use of the pre-paid rebate cards. A further benefit includes the ability to track consumer spending habits through use of the pre-paid rebate card. Such information may be very helpful in designing better marketing and rebate programs for consumers. Through the collection of this type of data, merchants may identify specific individual consumers for targeted rebate offers, analyze general demographic trends among large groups of consumers, determine whether the pre-paid rebate cards are being used, determine where the pre-paid rebate cards are being used most, etc.

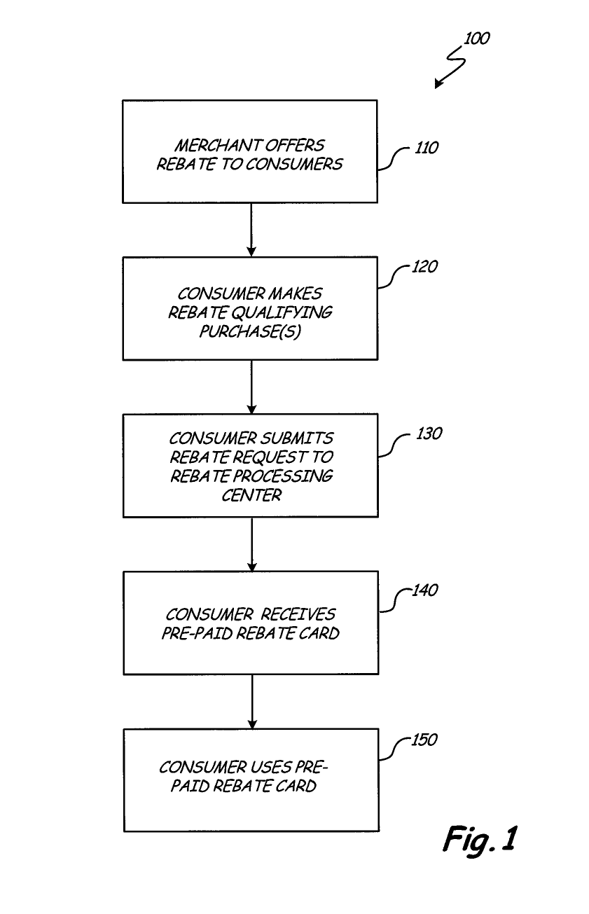

FIG. 1 illustrates a general pre-paid rebate card system and method 100 in accordance with one embodiment of the present invention. At step 110, a merchant may offer a rebate to consumers. In some embodiments, this may include notifying the consumer of the rebate offer. Typically, notification may be a written or oral communication indicating the terms of the rebate offer and instructing consumers with regard to satisfaction of the rebate offer. For example, consumers may be notified by a mass distributed flyer or advertisement. Such notifications may appear within printed or electronic media such as newspapers, magazines, journals and the like, internet publications or other internet websites, or any other advertising medium. Additionally, the notifications may be in the form of an email or delivered mail. Other forms of notification, such as oral communication or radio and television advertisements, are contemplated to be within the scope of the present invention. In some embodiments, consumers do not learn of the rebate offer until after entering a merchant's physical or internet location.

In some embodiments, a merchant may offer a rebate in situations where a consumer purchases a particular item, multiple items, or a combination of items, including items purchased in a single transaction or through multiple transactions, which may further occur on different dates. In other embodiments, a merchant may offer a rebate for any reason the merchant desires, such as a promotional rebate or a prize rebate. A merchant may include any product manufacturer or other business entity that provides goods or services to the public or other private or public entities.

At step 120, a consumer may make a purchase or multiple purchases that qualify the consumer for the rebate offered. Typically, the consumer may travel to a merchant to make a qualifying purchase. In other embodiments, it may not be necessary for the consumer to purchase the item or items at the merchant's physical location, and the consumer may purchase the item by other means, such as by mailing an order form or telephonically or electronically submitting an order. In a further embodiment, consumers may make a qualifying purchase in an electronic format, such as through designated sites connected to a global computer information network and accessible to the consumers through the global computerized information network. A global computer information network, such as the internet, may contain any number of websites that a user may access. Such websites may provide information for purchasing products and provide user interfaces through which users may transmit information about themselves, a product order, a credit card number, and the like.

Upon completion of a qualifying purchase, in some embodiments, a transaction may be recorded by a point-of-sale data processing and storage system. Typical point-of-sale data processing and storage systems may comprise a computerized system that receives purchase data either by manual entry by an operator or through scanning a Universal Product Code (“UPC”) supplied on the product packaging by either the merchant or the manufacturer. Often, the recording for each qualified purchase may include a transaction identifier or unique identification number (“UIN”). In one embodiment, the UIN may also be recorded on a receipt issued to the consumer. The receipt may be issued to the consumer directly, in the case of an in-store purchase, or electronically transferred to the consumer, in the case of an electronic purchase. An electronic receipt may be in the form of a transfer across a computer network, such as the internet. The point-of-sale data processing and storage system may be any system known in the art for recording and processing purchases at the point of sale.

In another embodiment, after making a qualifying purchase, consumers may be provided with a primary receipt and a secondary receipt. The secondary receipt may comprise a record of information associated with the qualifying purchase, including the UIN, whereas the primary receipt may consist essentially of information associated with all purchases, including items not associated with rebate offers. The secondary receipt may also contain information with regard to how consumers may perfect satisfaction of the rebate offer. In another embodiment, the information contained on the primary receipt and secondary receipt, as described above, may comprise a single receipt.

In some embodiments, the rebate processing center may receive reports from the point-of-sale data processing and storage systems comprising a plurality of purchase data records, e.g., information relating to the sales transactions for the merchant. In one embodiment, a purchase data record may comprise a list of the products purchased by a consumer, the date of the purchase transaction, and the UIN. The purchase data record may include a list of all the products purchased during the transaction and not merely the products associated with a rebate offer. Alternatively, to minimize the purchase data report file size, the purchase data records may be limited to include only the purchased items associated with a rebate offer. The purchase data record may also comprise other data such as the store number, the purchase price of each product purchased, etc. In one embodiment, the report may comprise only those purchase data records having information relating to sales transactions including items associated with rebate offers. In a further embodiment, the rebate processing center may receive the reports electronically, in the form of a transfer across the internet or a tangible electronic storage device containing the electronic file. The report may also be delivered via mail or courier service. Additionally, the rebate processing center may receive the reports of purchase data items on a periodic basis, such as daily, weekly, or other suitable periodic basis. In other embodiments, the rebate processing center may receive the reports at non-regular intervals, such as dates specified by the merchant or rebate processing center.

Subsequently, the consumer may submit a rebate claim to a rebate processing center, as shown at step 130. A rebate claim may comprise the submission by the consumer of a rebate claim form. A rebate claim form may generally request transaction information, including the UIN, and selected portions of consumer information. Additionally, a rebate claim form may include a destination address, rebate promotion information, and instructions for submitting material verifying the qualifying purchase, if necessary or desired. Consumer information may comprise any information that identifies or is associated with a particular consumer, such as the consumer's name, address, phone number, e-mail address, etc. Consumer information may also comprise of information regarding a particular consumer's more private information or lifestyle preferences and/or opinions, such as annual income, places where the consumer typically shops, items the consumer typically purchases, etc. Such information, if requested, may be useful in conducting consumer surveys and may typically be voluntarily offered by the consumer and not required to receive the rebate. Alternatively, in some embodiments, a rebate claim form may request only enough information to identify the consumer so that the rebate can be provided to the consumer.

In a traditional paper-based rebate system, a consumer may submit a rebate claim by recording personal information and qualifying UINs on a paper form and mailing the form to the rebate processing center. Although, the rebate claim may be submitted by recording the UINs on the paper form, in some embodiments, the consumer may submit the original receipts or copies of the receipts with the paper form for ease of validation.

In another embodiment, the rebate claim may be submitted by telephone. The consumer may place a call to a predetermined telephone number, which may, in some embodiments, be provided to the consumer by the merchant. In further embodiments, the predetermined telephone number may be provided on the receipt for the sales transaction. The predetermined telephone number may be connected to an interactive computerized telephone processing system, such as those used for voice-mail systems, customer service telephone lines, etc. In some embodiments, data requested by the interactive computerized telephone processing system may be received in the form of tones generated by the numeric keys of a touch-tone telephone. In other embodiments, voice recognition may be used to receive the data in the form of spoken response from the consumer.

In yet another embodiment, consumers may be able to access an electronic rebate claim form and submit an electronic rebate claim. For example, customers may be directed to a web page identified by a uniform resource locator (“URL”) and accessible using a web browser connected to the internet. The consumer may access the URL in several manners. In one embodiment, the consumer may access the URL using a menu option at the merchant's, manufacturer's, or rebate processing center's website. In some embodiments, the URL may appear to be the merchant's or manufacturer's website, but in fact be the rebate processing center's website that is merely linked to the merchant's or manufacturer's website. Additionally, the consumer may access the URL from any location. In one embodiment, the consumer may access the URL from a home computer system. Alternatively, the consumer may access the URL from a computer located at the merchant's location, such as an in-store kiosk. An electronic rebate claim form, accessible via the internet, may request similar information to that of the rebate claim form described above in that it may typically request transaction information, including the UIN, and selected portions of consumer information, and may include a destination address, rebate promotion information, and instructions for submitting material verifying the qualifying purchase. Alternatively, in some embodiments, an electronic rebate claim form may request only enough information to identify the consumer so that the rebate can be provided to the consumer.

In some embodiments, before being issued to the consumer, all or a portion of the information requested on the rebate request form may be provided, for example, by the merchant offering the rebate. In one embodiment, such may be the case where a purchase of an item or combination of items was made at the merchant's store or over the internet, and the merchant subsequently provides the consumer with the rebate claim form. In such cases, much of the consumer information may already be provided, or pre-filled in, on the rebate claim form by the merchant as such consumer information may have already been provided to the merchant for purposes of effectuating the sale of the item or combination of items. Alternatively, none of the consumer information may be pre-filled in, and the consumer may be required to fill in some or all of the information requested on the rebate request claim personally.

The consumer may submit a rebate claim by mail, telephone, internet, or any other suitable means for submitting a rebate claim. In one embodiment, the merchant may provide the consumer with instructions for submitting the rebate claim. In some embodiments, the consumer may not be aware of the involvement of the rebate processing center and may submit the rebate claim to the merchant, e.g., by addressing the rebate claim to the merchant, electronically submitting the rebate claim at the merchant's internet website, etc. The merchant may then forward the rebate claim to the rebate processing center.

At step 140, in response to the rebate claim, the consumer may receive a pre-paid rebate card. As previously mentioned, a pre-paid rebate card in accordance with an embodiment of the present invention may include any debit or credit card, including Visa®, Mastercard®, Discover®, American Express®, or other credit card, loyalty card, smartcard, scannable device, or other card or device suitable for storing information relating to a pre-paid rebate card or rebate offer. In some embodiments, the pre-paid rebate card may be a pre-paid credit card. In further embodiments, the pre-paid rebate card may require activation subsequent to receipt of the pre-paid rebate card by the consumer. In some embodiments, the consumer may activate the pre-paid rebate card by telephone or electronically over the internet.

After receipt of the pre-paid rebate card, the consumer may use the pre-paid rebate card to purchase goods or services, as shown at step 150. In further embodiments, the pre-paid rebate card may be used at any merchant that accepts payment by credit, including the merchant that offered the initial rebate or other outside merchant. In some embodiments, the consumer may use the pre-paid rebate card a plurality of times until the value of the pre-paid rebate card has been substantially or completely used. For example, the consumer may make multiple transactions at multiple locations using the same pre-paid rebate card. The pre-paid rebate card may be, or may be similar to, a credit card, such that the pre-paid rebate card may be swiped in a credit card scanning device at the time of purchase and the pre-paid rebate card information may be automatically entered into the point-of-sale data processing and storage system. Alternatively, the pre-paid rebate card may contain a unique number, such as a credit card number, that an operator may manually enter into the point-of-sale data processing and storage system.

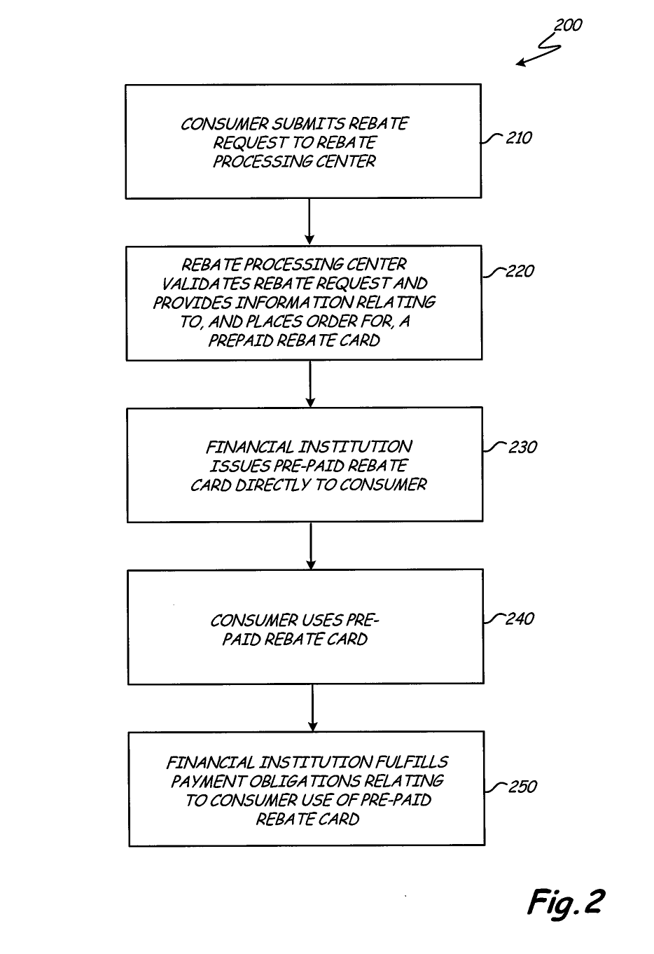

FIG. 2 illustrates a general pre-paid rebate card system and method 200 in accordance with one embodiment of the present invention, including portions that may not directly involve the consumer. In other words, FIG. 2 illustrates a general pre-paid rebate card system and method 200 including portions where the consumer does not directly participate.

At step 210, a consumer may submit a rebate claim to a rebate processing center, as was previously described in detail. The consumer may submit a rebate claim by mail, telephone, internet, or any other suitable means for submitting a rebate claim. In one embodiment, the merchant may provide the consumer with instructions for submitting the rebate claim. In some embodiments, the consumer may not be aware of the involvement of the rebate processing center and may submit the rebate claim to the merchant, e.g., by addressing the rebate claim to the merchant, electronically submitting the rebate claim at the merchant's internet website, etc. The merchant may then forward the rebate claim to the rebate processing center.

At step 220, upon receipt of the rebate claim, in some embodiments, the rebate processing center may verify that the rebate claim corresponds to a valid qualifying purchase. Validating rebate claims may be done in any manner known in the art, and no particular method of validation is particular to the system and method of the present invention. In one embodiment, a rebate processing employee may manually validate the rebate claim. In a further embodiment, the rebate processing employee may validate the rebate claim by verifying the UINs provided by the consumer, verifying the items purchased qualify for a rebate offer, verifying the purchase was made during the qualifying time period, if any, and/or verifying other purchase details, such as number of items purchased, valid receipt information, etc., to be sure that the rebate claim meets initial criteria. In another embodiment, the rebate processing center may employ a computerized software that matches the UINs provided by the consumer on the rebate claim with the UINs provided to the rebate processing center in the purchase data records provided in the point-of-sale data processing and storage system reports, described above. The computerized software may further validate the rebate claim by verifying the items purchased qualify for a rebate offer, verifying the purchase was made during the qualifying time period, if any, and/or verifying other purchase details, such as number of items purchased, valid receipt information, etc. The computerized software may also automatically calculate the rebate total based on the purchase data records. For example, the computerized software, in one embodiment, may automatically determine which items, or combination of items, from a purchase data record are associated with a rebate offer or rebate offers, and determine the total rebate value owed to the consumer. In some embodiments, the total rebate value owed to a consumer may be determined from the items purchased across multiple sales transactions evidenced by multiple purchase data records.

Hardware and software components used by the rebate processing center may be integral portions of a single computer or server or may be connected parts of a computer network. The hardware and software components may be located within the rebate processing center or may be operated offsite by a third-party subcontractor. In other embodiments, portions of the hardware and software components may be divided among a plurality of locations and connected directly or through a global computer information network, such as the internet.

Any combination of consumer identifying information, such as name, address, e-mail address, and the like and purchase identifying information, such as purchase location, purchase date, purchase item, and the like may further be used to validate the rebate claim in lieu of, or in addition to, the UIN. Alternatively, an operator may be employed to manually validate the rebate claims. Additionally, the rebate processing center may contact the merchant to verify that a qualifying purchase was made. The preceding examples of validation methods are meant only to provide examples of particular embodiments. The systems and methods of the present invention contemplate any form of validating a rebate claim. Similarly, the rebate processing center may bypass validation, or validation may be performed by another entity in lieu of the rebate processing center.

The rebate processing center may similarly check the rebate claims for fraud, for example, by comparing the name and address of the consumer to known databases containing consumer identities that may be suspicious or have previously been determined to act fraudulently. In other embodiments the fraud-checking step may be performed by an entity other than the rebate processing center or may be omitted entirely.

The rebate processing center may also provide information from a rebate claim to a financial institution. Information may be provided to the financial institution by mail, e-mail, or other electronic form, such as an electronic batch transfer, etc. In one embodiment, the information may be provided to the financial institution on a periodic basis, such as daily, weekly, or other suitable periodic basis. In other embodiments, the information may be provided to the financial institution at non-regular intervals, such as upon request by the financial institution. In a further embodiment, the rebate processing center may provide the information from a rebate claim with an order or request for the financial institution to issue a pre-paid rebate card. In other embodiments, the information may be provided separately from an order or request for the financial institution to issue a pre-paid rebate card. For example, the rebate processing center may place an order for a predetermined amount of pre-paid rebate cards for which the rebate processing center may later provide information that the financial institution can use to issue the pre-paid rebate cards. In other words, the rebate processing center may pre-order a bulk amount of pre-paid rebate cards for which the rebate processing center will subsequently provide information relating to which consumers the financial institution should issue pre-paid rebate cards.

As shown in step 230, the financial institution may supply and issue the pre-paid rebate cards. In a further embodiment, the financial institution may also print the pre-paid rebate cards. That is, the financial institute may imprint the necessary data, such as the consumers name and a unique card number, on the pre-paid rebate cards. In some embodiments, the financial institution may issue the pre-paid rebate cards directly to the consumers. The information the financial institution may use to issue the pre-paid rebate cards directly to the consumers (e.g., consumer names, addresses, etc.) may be provided with the information received from the rebate processing center. In further embodiments, the financial institution may be a federal bank.

After the financial institution issues the pre-paid rebate card to the consumer, the consumer may use the pre-paid rebate card to purchase goods or services, as shown at step 240. In further embodiments, the pre-paid rebate card may be used at any merchant that accepts payment by credit, including the merchant that offered the initial rebate or other outside merchant. In some embodiments, the consumer may use the pre-paid rebate card a plurality of times until the value of the pre-paid rebate card has been substantially or completely used. For example, the consumer may make multiple transactions at multiple locations. In some embodiments, before the consumer may use the pre-paid rebate card, the pre-paid rebate card may require activation by the consumer. In some embodiments, the consumer may activate the pre-paid rebate card by telephone or electronically over the internet.

When a consumer uses the pre-paid rebate card to purchase goods or services, the financial institution may fulfill payment obligations associated with consumer use of the pre-paid rebate card. Such obligations may be similar to those obligations with respect to the use of a credit card. For example, the financial institution may fulfill payment obligations to the sales merchant, the network supplying a connection between the financial institution and the sales merchant or other intermediary parties involved in the transaction, and/or the processor of the transaction, etc. In one embodiment, the total payment obligation for the financial institution for each pre-paid rebate card is at, or near, face value of the pre-paid rebate card.

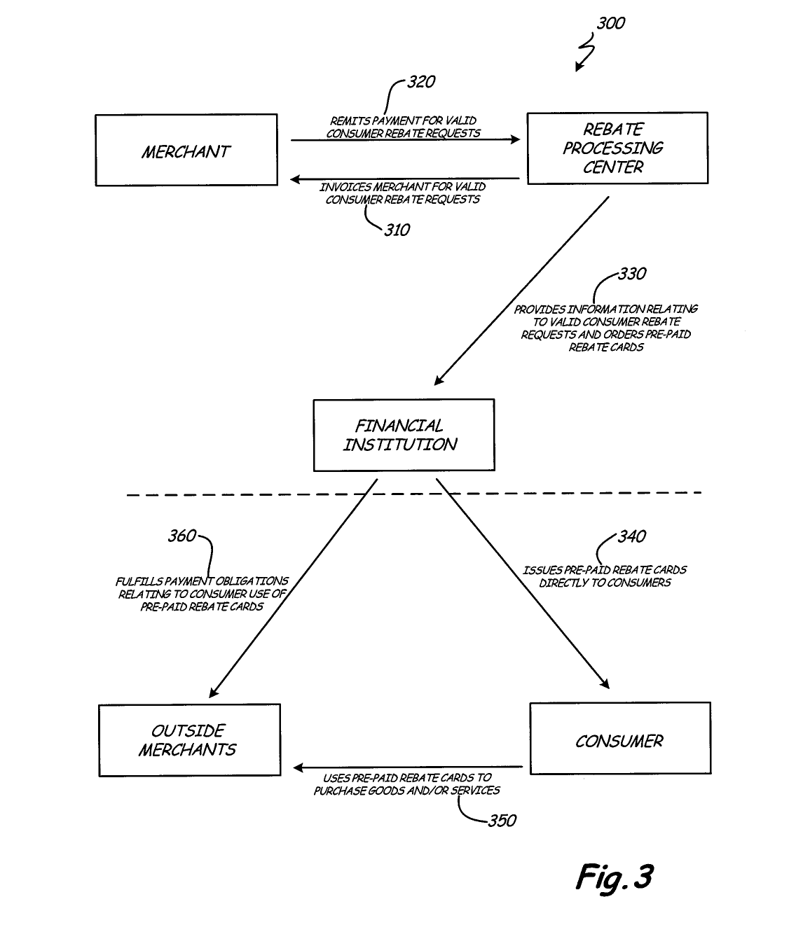

FIG. 3 illustrates a three-party agreement 300 for a system and method of providing pre-paid rebate cards in accordance with one embodiment of the present invention. The three-party agreement 300 may include a merchant offering a rebate, a rebate processing center, and a financial institution supplying pre-paid rebate cards. In some embodiments, the rebate processing center may be, or act as, an agent for the financial institution.

As shown in step 310, the rebate processing center may invoice the merchant for the value of the rebate claims submitted by consumers. In a further embodiment, the rebate processing center may invoice the merchant for the value of only the rebate claims that have been validated. As previously described, validating rebate claims may be done in any manner known in the art, and no particular method of validation is particular to the system and method of the present invention. Similarly, the rebate processing center may bypass validation, or validation may be performed by another entity in lieu of the rebate processing entity.

In addition to rebate claim validation, the rebate processing center may provide further services for the merchant, including but not limited to, providing the pre-paid rebate cards, rebate processing or other processing, customer service, and fulfillment of the pre-paid rebate cards (e.g., through the financial institution). In some embodiments, the rebate processing center may be a direct contact point for the merchant and provide the consumers of the merchant with pre-paid rebate cards and fulfillment services. In such an embodiment, the rebate processing center may contract out the services of issuing and fulfilling the pre-paid rebate cards to the financial institution. In other embodiments, the rebate processing center may act as an agent of the financial institution. In yet other embodiments, the services provided to the merchant by the rebate processing center may include customer service for the pre-paid rebate cards. For example, the rebate processing center may take customer service inquiries or telephone calls relating to problems during issuance of the pre-paid rebate cards, problems during activation of the pre-paid rebate cards, balance inquiries, etc. In other embodiments, the merchant or the financial institution may handle customer service issues.

The merchant, in response to the invoices received from the rebate processing center, may remit payment to the rebate processing center for the consumer rebate claims, as illustrated at step 320. In one embodiment, the merchant may remit payment to the rebate processing center for only those rebate claims which have been validated by the rebate processing center.

At step 330, the rebate processing center may provide information relating to the consumer rebate claims to the financial institution. Information may be provided to the financial institution by mail, e-mail, or other electronic form, such as an electronic batch transfer, etc. In one embodiment, the information may be provided to the financial institution on a periodic basis, such as daily, weekly, or other suitable periodic basis. In other embodiments, the information may be provided to the financial institution at non-regular intervals, such as upon request by the financial institution. In some embodiments, the information provided to the financial institution relates to only those consumer rebate claims that have been validated by the rebate processing center. Also as shown at step 330, the rebate processing center may order or request pre-paid rebate cards for the validated rebate claims. In one embodiment, the orders may be provided to the financial institution at the same time the information relating to the rebate claims is provided to the financial institution. In other embodiments, the information may be provided separately from the orders.

The financial institution, at step 340, may issue pre-paid rebate cards directly to the consumers based on the information provided by the rebate processing center. In other embodiments, the financial institution may issue the pre-paid rebate cards to the rebate processing center, which may then send the pre-paid rebate cards to the consumers. At step 350, the consumers may use the pre-paid rebate cards to purchase goods and/or services at any merchant, as was previously described. For example, the consumers may use the pre-paid rebate cards at any merchant that accepts payment by credit. Dashed lines surrounding the consumers and outside merchants are used to illustrate that the consumers and outside merchants are generally not participants of the three-party agreement between the merchant offering the rebate, the rebate processing center, and the financial institution supplying the pre-paid rebate cards. In some embodiments, however, the outside merchants or consumers may be part of agreements between the parties described herein.

In addition to issuing the pre-paid rebate cards, the financial institution may also fulfill payment obligations relating to consumer use of the pre-paid rebate cards, as shown at step 360. In some embodiments, the financial institution may fulfill payment obligations similar to those obligations with respect to the use of a credit card. For example, the financial institution may fulfill payment obligations to the sales merchant, the network supplying a connection between the financial institution and the sales merchant or other intermediary parties involved in the transaction, and/or the processor of the transaction, etc. In one embodiment, total payment obligation for the financial institution for each pre-paid rebate card is at, or near, face value of the pre-paid rebate card.

As previously stated, in some embodiments, the financial institution may be a federal bank. In further embodiments, the financial institution may assume at least some of the risks or losses of the merchant and/or rebate processing center arising from operation of the system and method described herein for providing pre-paid rebate cards and/or the three-party agreement, e.g., the purchase, marketing, and distribution of the pre-paid rebate cards, etc. In yet a further embodiment, the financial institution may assume a substantial portion of the risks or losses of the merchant and/or rebate processing center arising from operation of the system and method for providing pre-paid rebate cards and/or the three-party agreement. In other embodiments, the financial institution may indemnify the merchant and/or rebate processing center from, for example, liability under state consumer protection and privacy laws and statutory or common law fraud, embezzlement, theft, and conversion actions and proceedings, etc. In another embodiment, the financial institution may indemnify both the merchant and the rebate processing center.

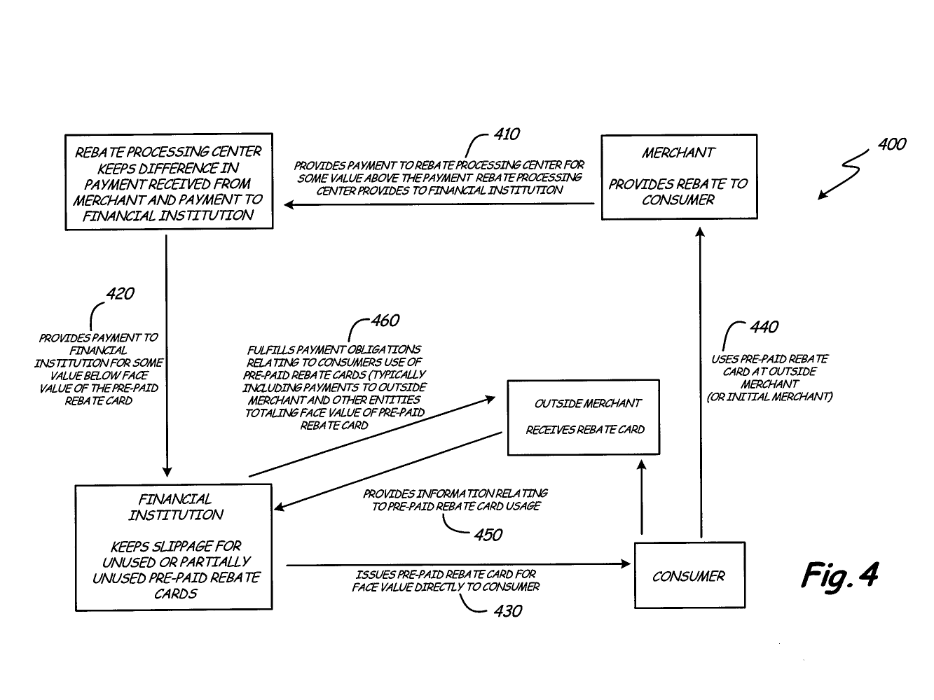

FIG. 4 illustrates a three-party agreement 400 for a system and method of providing pre-paid rebate cards in accordance with a further embodiment of the present invention. The three-party agreement 400 may include a merchant offering a rebate, a rebate processing center, and a financial institution supplying pre-paid rebate cards. In some embodiments, the rebate processing center may be, or act as, an agent for the financial institution.

As previously described, a merchant may offer a rebate to a consumer. As shown at step 410, the merchant may provide a monetary payment to the rebate processing center. In a further embodiment, the merchant may provide a monetary payment to the rebate processing center for some value above the monetary payment that the rebate processing center may provide to the financial institution for supplying and fulfilling the pre-paid rebate cards. In some embodiments, the merchant may provide a monetary payment to the rebate processing center for a value at, or near, face value of the pre-paid rebate cards. The payment to the rebate processing center from the merchant may include payment for, but is not limited to, the pre-paid rebate cards and software, hardware, or services associated with rebate processing, providing customer service, or other services the rebate processing center may provide throughout operation of the system and method provided herein. In other embodiments, the merchant may provide a monetary payment to the rebate processing center for a value below face value of the pre-paid rebate cards, such as where the rebate processing center provides only the pre-paid rebate cards to the merchant with fewer or no associated services. In yet other embodiments, the monetary payment to the rebate processing center may depend on certain economics of the operation of the system and method of the present invention and may be more or less than face value of the pre-paid rebate cards.

The rebate processing center may provide several services for the merchant, such as, but not limited to, providing the pre-paid rebate cards, rebate processing or other processing, customer service, and fulfillment of the cards (e.g., through the financial institution). In some embodiments, the rebate processing center may be, or act as, an agent for the financial institution. At step 420, the rebate processing center may provide a monetary payment to the financial institution. In a further embodiment, the rebate processing center may provide a monetary payment to the financial institution that is equal to some value below face value of the pre-paid rebate cards. In other embodiments, the rebate processing center may provide a monetary payment to the financial institution that is equal to, or above, face value of the pre-paid rebate cards and may depend on such things as economics, the agreement, what entity retains slippage revenue, etc.

The financial institution, in one embodiment, may print and issue the pre-paid rebate cards for the system and method of the present invention. As shown in step 430, the financial institution may issue the pre-paid rebate cards directly to the consumer. In some embodiments, the financial institution may retain slippage revenue associated with unused or partially unused pre-paid rebate cards. Rebate slippage may occur, for example, when consumers do not activate the pre-paid rebate cards, do not use the pre-paid rebate cards, or do not use the total value of the pre-paid rebate cards (e.g., when the consumer leaves a remaining balance on the pre-paid rebate card), etc. In other embodiments, the financial institution may provide the value, or portion of the value, associated with slippage to the rebate processing center, which in turn may provide the financial institution with a larger initial payment for the pre-paid rebate cards, including a payment of more than face value for the pre-paid rebate cards.

At step 440, the consumers, after receiving the pre-paid rebate cards, and in some embodiments activating the pre-paid rebate cards, may use the pre-paid rebate cards at any location that will accept the pre-paid rebate cards, such as any merchant that allows payment by credit. In some embodiments, the locations where consumers may use the pre-paid rebate cards include outside merchants or the merchant that initially offered the rebate to the consumers.

At step 450, a merchant where a consumer had used the pre-paid rebate card may provide information relating to the use of, or a transaction involving, the pre-paid rebate card to the financial institution. The information may be provided to the financial institution directly or indirectly, such as through a network provider and/or credit processor. At step 460, the financial institution may subsequently fulfill payment obligations associated with the transaction involving the pre-paid rebate card. In some embodiments, the payment obligations may include payments to the merchant involved in the transaction, a network providing communication between the financial institution and sales merchant or other intermediary party involved in the transaction, and/or the credit processor, etc. In further embodiments, the total payment obligation for the financial institution for each pre-paid rebate card is at, or near, face value of the pre-paid rebate card.

Although the present invention has been described with reference to preferred embodiments, persons skilled in the art will recognize that changes may be made in form and detail without departing from the spirit and scope of the invention. For example, it is recognized that multiple embodiments of rebate validation or other rebate processing may be suitable for use with the system and method of the present invention. Similarly, it is recognized that the rebate claim may be submitted by the consumer in accordance with traditional paper-based rebate systems or “paperless” rebate systems.

We claim:

1. A system for providing one or more pre-paid rebate cards comprising a first business entity, a second business entity, and a third business entity, wherein:
the first business entity provides a rebate offer to one or more consumers in relation to at least one of a purchase of an item, a purchase of a plurality of items, and a purchase of a combination of items;
the second business entity validates one or more rebate claims received from the one or more consumers and provides information relating to the one or more validated rebate claims to the third business entity; and
the third business entity issues, to the one or more consumers, one or more pre-paid rebate cards based on the information relating to the one or more validated rebate claims received from the second business entity, wherein the third business entity further fulfills payment obligations upon use of the one or more pre-paid rebate cards by the one or more consumers and assumes at least a portion of the risks or losses of at least one of the first and second business entities arising from operation of the system.

2. The system of claim 1, wherein the second business entity acts as an agent for the third business entity.

3. The system of claim 1, wherein the second business entity provides a first monetary amount of less than face value of the pre-paid rebate cards to the third business entity.

4. The system of claim 3, wherein the first business entity provides a second monetary amount of more than the first monetary amount to the second business entity.

5. The system of claim 4, wherein the second monetary amount is substantially equal to the face value of the pre-paid rebate cards.

6. The system of claim 4, wherein the third business entity retains the monetary value associated with slippage in use of the pre-paid rebate cards.

7. The system of claim 4, wherein the third business entity indemnifies at least one of the first and second business entities from at least a portion of the risks and losses arising from the system.

8. The system of claim 7, wherein the third business entity indemnifies the first and second business entities from liability under state consumer protection and privacy laws and statutory or common law fraud, embezzlement, theft, and conversion actions and proceedings.

9. The system of claim 1, wherein the first business entity is a merchant, the second business entity is a rebate processing center, and the third entity is a financial institution.

10. A method for providing a pre-paid rebate card in response to a request from a consumer for rebate redemption for a rebate offered by a first entity comprising:
providing information relating to the rebate redemption request to a second entity, wherein the second entity issues a pre-paid rebate card to the consumer and fulfills payment obligations upon subsequent use of the pre-paid rebate card by the consumer;
providing a first monetary amount to the second entity for a value less than face value of the pre-paid rebate card;
receiving a second monetary amount from the first entity for a value more than the first monetary amount; and
obtaining indemnification from the second entity from at least a portion of the risks and losses arising from the method.

11. The method of claim 10, wherein the second monetary amount is substantially equal to face value of the pre-paid rebate card.

12. The method of claim 10, wherein obtaining indemnification from the second entity comprises obtaining indemnification from liability under state consumer protection and privacy laws and statutory or common law fraud, embezzlement, theft, and conversion actions and proceedings.

13. The method of claim 10, wherein the first entity is a merchant and the second entity is a financial institution.

14. A method for providing one or more pre-paid rebate cards in response to a request for one or more pre-paid rebate cards from a first entity comprising:
receiving from the first entity a first monetary amount of less than face value of the one or more pre-paid rebate cards;
issuing one or more pre-paid rebate cards to one or more consumers based on information provided by the first entity;
fulfilling payment obligations relating to use of the one or more pre-paid rebate cards by the one or more consumers; and
assuming at least a portion of the risks or losses of the first entity arising from the method.

15. The method of claim 14, wherein assuming at least a portion of the risks or losses of the first entity comprises indemnifying the first entity from at least a portion of the risks and losses arising from the method.

16. The method of claim 15, wherein assuming at least a portion of the risks or losses of the first entity comprises indemnifying the first entity from liability under state consumer protection and privacy laws and statutory or common law fraud, embezzlement, theft, and conversion actions and proceedings.

17. The method of claim 14, further comprising retaining the monetary value associated with slippage in use of the pre-paid rebate cards.

18. A system provided by a first entity for providing one or more pre-paid rebate cards for a rebate offered by a second entity comprising:
means for receiving submission of at least one rebate request from the consumers for the one or more pre-paid rebate cards;
means for validating the at least one rebate request;
means for providing to a third entity a first monetary amount of less than face value of the one or more pre-paid rebate cards; and
means for receiving from the second entity a second monetary amount for a value more than the first monetary amount;
means for providing the third entity with information, wherein the third entity issues the one or more pre-paid rebate cards to consumers based on the information provided, fulfills payment obligations relating to use of the one or more pre-paid rebate cards by the consumers, and assumes at least one of the first and second entities from at least a portion of the risks or losses arising from the system.

19. The system of claim 18, wherein the third entity indemnifies at least one of the first and second entities from at least a portion of the risks and losses arising from the system.

20. The system of claim 18, wherein the means for receiving submission of at least one rebate request allows the consumers to submit the at least one rebate request electronically.

21. The system of claim 18, wherein the means for validating the at least one rebate request comprises computerized software for automatically validating the at least one rebate request and automatically calculating the rebate total.

22. The system of claim 18, wherein the at least one of the means for providing to a third entity a first monetary amount, means for receiving from the second entity a second monetary amount, and means for providing the third entity with information are electronic means.

23. The system of claim 18, wherein the third entity retains the monetary value associated with slippage in use of the pre-paid rebate cards.
